(19) United States
(12) Patent Application Publication
(10) Pub. No.: US 2015/0100945 A1
(43) Pub. Date: Apr. 9, 2015

(54) RESUMING A SOFTWARE BUILD PROCESS

(71) Applicant: International Business Machines Corporation, Armonk, NY (US)

(72) Inventors: Kumarasun M. Nadar, Mumbai (IN); Mohit M. Velaskar, Mumbai (IN)

(73) Assignee: International Business Machines Corporation, Armonk, NY (US)

(21) Appl. No.: 14/048,961

(22) Filed: Oct. 8, 2013

(51) Int. Cl. G06F 9/44; G06F 9/45

(52) U.S. Cl. CPC G06F 8/71; G06F 8/40
USPC 717/121

(57) ABSTRACT

A computer resumes a software build process following a build process fail. Upon a failure of a build process executing a build plan, the computer saves the state of the build process. After the computer receives an indication from a versions control system that a source code module has been checked-in, the computer determines the modules in the build plan that are dependent on the checked-in source code file. The computer creates an interim build plan based, at least in part, on the determined modules in the build plan that are dependent on the checked-in source code module and the saved state of the build process. The computer then automatically executes the interim build plan.

### FIELD OF THE INVENTION

The present invention relates generally to the field of software development tools, and more particularly to software development tools for project compilation and build.

### BACKGROUND OF THE INVENTION

In the field of software development tools, the term software build refers either to the process of converting source code files into standalone software artifact(s) that can be run on a computer, or the software artifact that results from the conversion process. An important step of a software build is the compilation process where source code files are converted into executable code. One example of an artifact is the bytecode (the executable code) produced in a compilation of the software build from Java® source code files.

For complex software projects, the source code may be separate modules spread across many source files. A module can be a discrete unit of functionality which can be compiled, run, tested and debugged independently. Modules can contain everything that is required for their specific tasks including: source code, build scripts, unit tests, deployment descriptors, and documentation. The software project's source files typically go through many revisions before a software build is complete. To track source code file revisions, a version control system (VCS) can provide control over the multiple revisions made to the source code files during the development phases of a software project.

Build automation is the act of scripting or automating a wide variety of tasks that software developers do in their day-to-day activities including: compiling computer source code into executable code, packaging executable code, running tests on executable code, deployment of the build to production systems, and creating documentation and/or release notes for the project build.

Continuous integration (CI) is the practice of merging all developer working copies into a shared repository several times a day. The aim is to prevent integration problems that result from multiple changes occurring simultaneously across multiple modules. Continuous integration servers can automatically rebuild the software project and run the unit tests periodically, or even after every submission of a working copy to the VCS, and report the results to the developers.

### SUMMARY

Embodiments of the present invention provide for a program product, system, and method in which a computer resumes software build process following a build process fail. Upon a failure of a build process executing a build plan, the computer saves the state of the build process. After the computer receives an indication from a version control system that a source code file has been checked-in, the computer determines the modules in the build plan that are dependent on the checked-in source code file. The computer creates an interim build plan based, at least in part, on the determined modules in the build plan that are dependent on the checked-in source code module and the saved state of the build process. The computer then automatically executes the interim build plan.

### BRIEF DESCRIPTION OF THE SEVERAL VIEWS OF THE DRAWINGS

FIG. 1 is a block diagram illustrating a software development system, in accordance with one embodiment of the present invention.

FIG. 2 is a flowchart showing the operational steps of a resume logic module of a software development system of FIG. 1 in accordance with an embodiment of the present invention.

FIG. 3 is a functional block diagram of a computer system in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” or “system.” Furthermore, aspects of the present invention may take the form of a computer program product embodied in one or more computer-readable medium(s) having computer-readable program code/instructions embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, or semiconductor system, apparatus, or device, or any suitable combination of the foregoing. More specific examples (a non-exhaustive list) of the computer-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

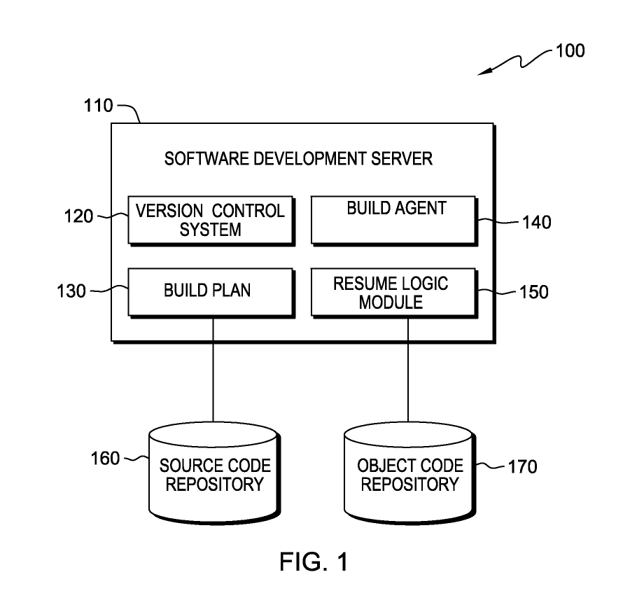

The present invention will now be described in detail with reference to the Figures. FIG. 1 is a block diagram illustrating software development system 100, in accordance with one embodiment of the present invention. Software development system 100 includes software development server 110 coupled to source code repository 160 and object code repository 170.

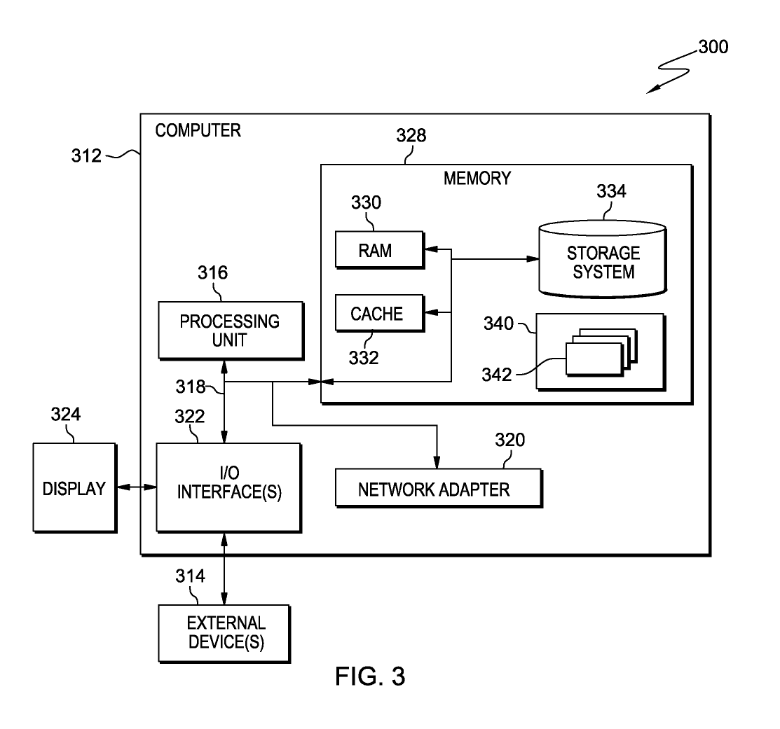

Software development server 110 represents a computing device, system, or environment that hosts version control system 120, build plan 130, build agent 140, and resume logic module 150. Software development server 110 may be a laptop computer, a notebook computer, a personal computer (PC), a desktop computer, a tablet computer, a thin client, a continuous integration server, or any other electronic device or computing system capable of performing the required functionality of embodiments of the invention. Software development server 110 may include internal and external hardware components, as depicted in further detail with respect to FIG. 3. In other embodiments of the invention, software development server 110 may represent a computing system utilizing clustered computers and components that act as a single pool of seamless resources.

Source code repository 160 operates to store the source code modules of a software project, and object code repository 170 operates to store the compiled executable modules of a software project. Source code repository 160 and object code repository 170 represent computer-readable storage media coupled to software development server 110, and may be tangible storage devices, such as storage system 334 (see FIG. 3), network storage devices, distributed storage, or any combination of these, capable of performing the required functionality of embodiments of the invention.

Version control system 120 operates to manage changes to the files and modules of a software project that are stored in source code repository 160 or object code repository 170. Changes may be identified by a number or letter code called the revision number, and may also include a timestamp indicating the date and time of the change. For example, a developer may request, via version control system 120, to receive, or “check-out,” a module or file from source code repository 160 in order to make changes to the program source code. After completing the changes, the developer may then save, or “check-in,” the changes, via version control system 120, to source code repository 160. Version control system 120 may then save the new source code file, updating the revision number and timestamp information. Version control system 120 may also archive previous revisions of the source code file, preserving the revision details and timestamp information, in the event a previous revision is required (e.g., for debugging purposes).

Build plan 130 operates to provide directions on how a software project is to be built. In particular, build plan 130 defines dependencies between source file and object file modules. The build plan utilizes components of the build that include, but are not limited to: source files, source modules, libraries, object modules, and scripts. The build plan utilizes components stored on source code repository 160 in accordance with embodiments of the invention. Build plan 130 uses a “make file” that includes the dependencies and the commands required by the Make utility to compile and link the files. Apache Maven uses an XML file named pom.xml to define the project build, where “POM” stands for project object module. The POM contains the necessary information about a project build including dependencies on other modules and components, the build order, directories, and required plug-ins. Larger projects can be divided into several modules, or sub-projects, each with its own POM. A root POM can then be written through which all of the modules can be compiled with a single command. The example illustrated in Table 1 below shows a POM for a software project consisting of six individual modules, indicated as module1 through module6 in the module section of the POM. In this example, the six modules are built in the order as defined in the pom.xml file.

TABLE 1
Project Object Module

```
<?xml version=″1.0″ encoding=″UTF-8?>
<project>
  <modelVersion>4.0.0</modelVersion>
  <groupId>myProjectGroupid</groupId>
      <artifactId>myProject</artifactId>
  <packaging>pom</packaging>
  <version>9.0</version>
  <name>WBSF</name>
  <organization>
      <name>IBM</name>
      <url>http://www.ibm.com/</url>
  </organization>
  <modules>
    <module> module1</module>
    <module> module2</module>
    <module> module3</module>
    <module> module4</module>
    <module> module5</module>
    <module> module6</module>
  </modules>
  <description></description>
</project>
```

In an embodiment of the invention, build plan 130 may be created manually by a software developer or build administrator by analyzing the dependencies of the various modules. In other embodiments of the invention, build plan 130 may be created automatically by build agent 140, for example, by scanning the dependencies of the various modules and determining an order in which to build the project. In still another embodiment, build plan 130 may be produced from a hybrid method of a software developer or build administrator working in conjunction with automation tools to produce build plan 130.

Build agent 140 operates to generate software builds based on build plan 130. Build agent 140 receives and executes the build plan and, in most cases, produces either a syntactically error-free executable module or produces an error log that identifies errors in the build. Build agent 140 can be any commercially available, open-source build automation tool, or custom developed tool, that directly supports, or will support, user enhancements capable of implementing the functionality of resume logic module 150, as described below, in accordance with embodiments of the present invention. Examples of build agents include, but are not limited to, Make, Apache Ant™, and Apache Maven™.

Resume logic module 150 operates generally to resume a software build process following a build fail. Resume logic module 150 can be an element of build agent 140, a plug-in module, or an external executable program file. A software build can fail or stop for a variety of reasons including, but not limited to: compilation error, unit test fail, build process runtime error, build process insufficient memory, or build process insufficient disk space. According to an embodiment of the invention, if an event occurs that stops a software build process, resume logic module 150 can store a copy of the current build plan and the object code file(s) produced by build agent 140 up to the point of the build fail. If, for example, the build process failure was the result of a compilation error, a developer may check-out a source code file or files and make appropriate edits to the source code. The developer then checks-in the updated source code file(s) to version control system 120. Resume logic module 150 determines if a source code file has been “checked-in,” for example, by polling version control system 120 based on the revision number or the timestamp, and further determines the module affected by the check-in of the updated source code file. Based on the check-in of the source code file, resume logic module 150 updates the copy of build plan 130 to create an interim build plan that includes the affected module and any modules not built due to the build fail. Further, resume logic module 150 updates the saved object code files to include the object code up to, but not including the affected module. Resume logic module 150 then resumes the build process using the interim build plan. In another embodiment, resume logic module 150 can create the interim build plan and updated object code file(s) based on the check-out of a source code module such that the interim build plan is ready to execute upon check-in of the previously checked-out source code module.

For example, the software build controlled by the POM example in Table 1 above stops due to a compilation error while building module 5. Resume logic module 150 saves a copy of build plan 130 and the object code files produced by the build up to the point of the compilation error. A software developer determines that the cause of the error is a problem with a source code file located in module 4. The software developer checks-out the source code file from version control system 120 and makes the necessary edits to the source code. The software developer checks-in the updated source code file to version control system 120, whereby version control system 120 updates the revision and/or timestamp information of the checked-in source code file. Based on polling of version control system 120, resume logic module 150 determines the check-in of the source code file and further determines that the checked-in source code file is located in module 4. Resume logic module 150 updates the saved object code files to include the object code up to, but not including module 4. Resume logic module 150 creates an interim build plan, by updating the saved copy of build plan 130, that builds module 4 and all subsequent modules. Table 2 shows an example of the updated pom.xml file from Table 1, illustrating the interim build file.

TABLE 2
Interim Project Object Module

```
<?xml version=″1.0″ encoding=″UTF-8?>
<project>
  <modelVersion>4.0.0</modelVersion>
  <groupId>myProjectGroupid</groupId>
      <artifactId>myProject</artifactId>
  <packaging>pom</packaging>
  <version>9.0</version>
  <name>WBSF</name>
  <organization>
      <name>IBM</name>
      <url>http://www.ibm.com/</url>
  </organization>
  <modules>
    <module> module4</module>
    <module> module5</module>
    <module> module6</module>
  </modules>
  <description></description>
</project>
```

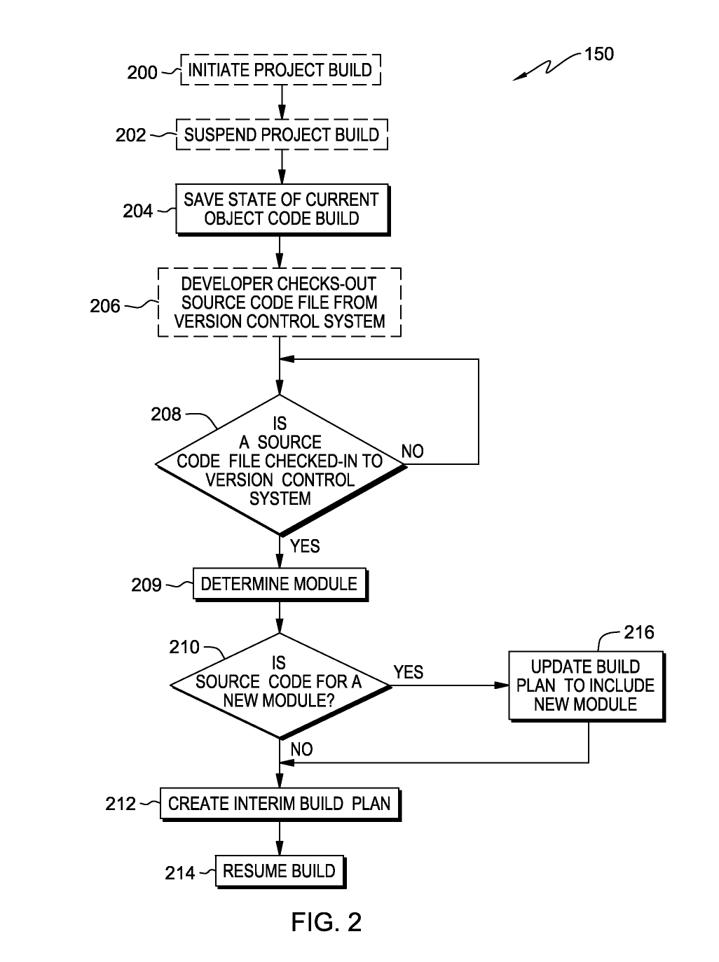

FIG. 2 is a flowchart showing the operational steps of resume logic module 150 of software development system 100 of FIG. 1 in accordance with an embodiment of the present invention. Steps that occur external to resume logic module 150 are indicated by a dashed-line border. The build of a software project is initiated via build agent 140 according to build plan 130 (step 200). The build can be initiated by a build administrator or a software developer. In various embodiments, the build can be initiated by a continuous integration server on a predetermined schedule. Subsequent to a build process failure, the project build is suspended (step 202). Resultant from the suspension of the build process, resume logic module 150 saves the state of the current object code build (step 204). The state can include the object code files, libraries, and build plan 130.

In an embodiment, when the build fails because of an error caused by a source code file, a software developer checks-out the applicable source code file from version control system 120 (step 206). The developer can edit the checked-out source code file to make corrections or edits to fix the errors. In various embodiments, the developer can run diagnostics and tests on the individual source code file prior to checking-in the file into version control system 120. In other embodiments, the developer may create a new source code file in order to fix the build error. After completion of editing and testing of the source code file, the developer checks-in the source code file to version control system 120. Resume logic module 150 polls version control system 120 to determine if a source code file has been checked-in. If a check-in is not detected (decision step 208, “NO” branch), resume logic module 150 continues to poll version control system 120. If a check-in is detected (decision step 208, “YES” branch) resume logic module 150 determines the module that includes the checked-in source code file (step 209). Resume logic module 150 determines if the checked-in source code is for a new module (step 210). For example, if the module that includes the checked-in source code file is in build plan 130, then it is not a new module (decision step 210, “NO” branch). Resume logic module 150 then creates an interim build plan (step 212). The interim build plan includes those modules subsequent to and dependent on the updated module. Resume logic module 150 then continues the build of the software project using the created interim build plan (step 214).

If the checked-in source code module is a new module (decision step 210, “YES” branch) build plan 130 is updated to include the addition of the new module (step 216). The update can be made by the software developer or build administrator and is based on the dependencies of the new module. In other embodiments, the updated build plan can be created automatically by build agent 140 by scanning the dependencies of the various project modules and the new module and determining the order in which to build the project. Resume logic module 150 then uses the newly updated build plan to create an interim build plan (step 212) to include those modules subsequent to and dependent on the checked-in source code module. Resume logic module 150 then continues the build of the software project using the created interim build plan (step 214).

Referring now to FIG. 3, a functional block diagram of a computer system in accordance with an embodiment of the present invention is shown. Computer system 300 is only one example of a suitable computer system and is not intended to suggest any limitation as to the scope of use or functionality of embodiments of the invention described herein. Regardless, computer system 300 is capable of being implemented and/or performing any of the functionality set forth hereinabove.

In computer system 300 there is computer 312, which is operational with numerous other general purpose or special purpose computing system environments or configurations. Examples of well-known computing systems, environments, and/or configurations that may be suitable for use with computer 312 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Software development server 110 can include or can be implemented as an instance of computer 312.

Computer 312 may be described in the general context of computer system executable instructions, such as program modules, being executed by a computer system. Generally, program modules may include routines, programs, objects, components, logic, data structures, and so on that perform particular tasks or implement particular abstract data types. Computer 312 may be practiced in distributed cloud computing environments where tasks are performed by remote processing devices that are linked through a communications network. In a distributed cloud computing environment, program modules may be located in both local and remote computer system storage media including memory storage devices.

As further shown in FIG. 3, computer 312 in computer system 300 is shown in the form of a general-purpose computing device. The components of computer 312 may include, but are not limited to, one or more processors or processing units 316, memory 328, and bus 318 that couples various system components including memory 328 to processing unit 316.

Bus 318 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 312 typically includes a variety of computer system readable media. Such media may be any available media that is accessible by computer 312, and includes both volatile and non-volatile media, and removable and non-removable media.

Memory 328 can include computer system readable media in the form of volatile memory, such as random access memory (RAM) 330 and/or cache 332. Computer 312 may further include other removable/non-removable, volatile/non-volatile computer system storage media. By way of example only, storage system 334 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 318 by one or more data media interfaces. As will be further depicted and described below, memory 328 may include at least one program product having a set (e.g., at least one) of program modules that are configured to carry out the functions of embodiments of the invention.

Program 340, having one or more program modules 342, may be stored in memory 328 by way of example, and not limitation, as well as an operating system, one or more application programs, other program modules, and program data. Each of the operating system, one or more application programs, other program modules, and program data or some combination thereof, may include an implementation of a networking environment. Program modules 342 generally carry out the functions and/or methodologies of embodiments of the invention as described herein. Version control system 120, build plan 130, build agent 140, and resume logic module 150 can be implemented as or can be an instance of program 340.

Computer 312 may also communicate with one or more external devices 314 such as a keyboard, a pointing device, etc., as well as display 324; one or more devices that enable a user to interact with computer 312; and/or any devices (e.g., network card, modem, etc.) that enable computer 312 to communicate with one or more other computing devices. Such communication can occur via Input/Output (I/O) interfaces 322. Furthermore, computer 312 can communicate with one or more networks such as a local area network (LAN), a general wide area network (WAN), and/or a public network (e.g., the Internet) via network adapter 320. As depicted, network adapter 320 communicates with the other components of computer 312 via bus 318. It should be understood that although not shown, other hardware and/or software components could be used in conjunction with computer 312. Examples, include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Based on the foregoing, a computer system, method, and program product have been disclosed for a system to resume a software build process. However, numerous modifications and substitutions can be made without deviating from the scope of the present invention. Therefore, the present invention has been disclosed by way of example and not limitation.

What is claimed is:

1. A method for resuming a software build process following a build process fail, the method comprising:
upon failure of a build process executing a build plan, saving the state of the build process;
receiving an indication from a version control system that a source code file has been checked-in to the version control system;
determining a module in the build plan that is dependent on the checked-in source code file;
creating an interim build plan based, at least in part, on the determined module in the build plan that is dependent on the checked-in source code file and, at least in part, on the saved state of the build process; and
automatically executing the interim build plan.

2. The method of claim 1, wherein the check-in is based on a revision change of the source code file.

3. The method of claim 1, wherein the check-in is based on a time stamp of the source code file.

4. The method of claim 1, wherein the source code file is a part of a module and the module is part of the build plan.

5. The method of claim 1, wherein the interim build plan includes the module affected by the check-in of the source code file, and any subsequent modules not built as a result of the build fail.

6. The method of claim 1, further comprising:
determining if the checked-in source code file is new.

7. The method of claim 6, wherein the build plan is updated to include the source code file based on the determination that the source code file is new.

8. A computer program product for resuming a software build process following a build process fail, the method comprising:
one or more computer-readable storage devices and program instructions stored on at least one of the one or more storage media, the program instructions comprising:
upon failure of a build process, program instructions to execute a build plan, saving the state of the build process;
program instructions to receive an indication from a version control system that a source code file has been checked-in to the version control system;
program instructions to determine a module in the build plan that is dependent on the checked-in source code file;
program instructions to create an interim build plan based, at least in part, on the determined module in the build plan that is dependent on the checked-in source code file and, at least in part, on the saved state of the build process; and
program instructions to automatically execute the interim build plan.

9. The computer program product of claim 8, wherein the check-in is based on a revision change of the source code file.

10. The computer program product of claim 8, wherein the check-in is based on a time stamp of the source code file.

11. The computer program product of claim 8, wherein the source code file is a part of a module and the module is part of the build plan.

12. The computer program product of claim 8, wherein the interim build plan includes the module affected by the check-in of the source code file, and any subsequent modules not built as a result of the build fail.

13. The computer program product of claim 8, further comprising:
program instruction to determine if the checked-in source code file is new.

14. The computer program product of claim 13, wherein the build plan is updated to include the source code file based on the determination that the source code file is new.

15. A system for resuming a software build process following a build process fail, the method comprising:
one or more computer-readable storage devices and program instructions stored on at least one of the one or more storage media, the program instructions comprising:
upon failure of a build process, program instructions to execute a build plan, saving the state of the build process;
program instructions to receive an indication from a version control system that a source code file has been checked-in to the version control system;
program instructions to determine a module in the build plan that is dependent on the checked-in source code file;
program instructions to create an interim build plan based, at least in part, on the determined module in the build plan that is dependent on the checked-in source code file and, at least in part, on the saved state of the build process; and
program instructions to automatically execute the interim build plan.

16. The system of claim 15, wherein the check-in is based on a revision change of the source code file.

17. The system of claim 15, wherein the source code file is a part of a module and the module is part of the build plan.

18. The system of claim 15, wherein the interim build plan includes the module affected by the check-in of the source code file, and any subsequent modules not built as a result of the build fail.

19. The system of claim 15, further comprising:
program instruction to determine if the checked-in source code file is new.

20. The system of claim 19, wherein the build plan is updated to include the source code file based on the determination that the source code file is new.
